(19) United States
(12) Patent Application Publication
(10) Pub. No.: US 2009/0051834 A1
(43) Pub. Date: Feb. 26, 2009

(54) OPTICAL PROTECTIVE FILTER AND METHOD FOR ITS MANUFACTURE

(75) Inventor: Kaspar Cottier, Jona (CH)

Correspondence Address: RANKIN, HILL & CLARK LLP, 38210 Glenn Avenue, WILLOUGHBY, OH, 44094-7808, US

(73) Assignee: SPERIAN WELDING PROTECTION AG, Wattwil (CH)

(21) Appl. No.: 12/128,143

(22) Filed: May 28, 2008

(30) Foreign Application Priority Data
May 29, 2007 (CH) 852/07

(51) Int. Cl. G02C 7/10; G02F 1/1335; B29D 11/00

(52) U.S. Cl. 349/14; 359/355; 264/1.7

(57) ABSTRACT

An optical protective filter (1, 3) includes at least one first and one second partial lens (1, 2), wherein the first partial lens (1) includes a flexible substrate (4). On the substrate (4), a thin film filter (2) is applied, and the thin film filter (2) comprises at least one metallic layer (8) with a layer thickness of between 2 nm and 100 nm. The substrate (4) in the completed protective filter, thanks to its flexibility, is bent into the final shape as a whole; this in contrast to such lenses, which while comprising a curved shape and curved surfaces, have been ground or cast into this curved shape.

### BACKGROUND OF THE INVENTION

The invention is related to the field of optical protective filters, in particular for laser protection filters and anti-dazzle filters. It relates to an optical protective filter and to a method for manufacturing an optical protective filter in accordance with the generic term (preamble) of the corresponding independent claims.

### DESCRIPTION OF RELATED ART

Optical protective filters are utilised, for example, as laser protection filters, in particular in the IR (infrared) range, or as anti-dazzle filters, such as, for example, protective filters for welders in masks or goggles for welders.

Available on the market are two types of IR protective filters, which are able to be utilised for laser protection: Absorption filters and thin film filters. It is also possible to combine the two. Thin film filters have a high transmission in the visible wave length range (VLT, visible light transmission), they do not, however, achieve a high optical absorption. In addition, the manufacturing of thin film filters of this kind onto the curved (bent) surfaces of protective glasses is associated with difficulties and expensive. In particular, the homogeneity of the layers and so-called “pin holes”, i.e., microscopic defects of the thin film, are problems which increase the reject rate of semi-finished products. In addition, the thin film filters are very susceptible to scratching, and as a rule, even if they are provided with a protective varnish, they cannot be utilised for applications in a rough environment. Both types of filters therefore, on the basis of absorption and on the basis of thin film filters, as a rule are only utilisable for a certain wavelength range. For environments, which manifest endangering by different wavelengths, for example, in the military field, and which therefore call for a broad band protection, different absorption filters and/or thin film filters have to be combined, which once again increases the manufacturing costs.

Known as base material for protection filters are mineral glass and plastic materials. In this, plastic glasses are lighter in weight, as a rule, however, they cannot withstand the high energy densities, which occur in the laser load tests prescribed by the various relevant safety standards for eye protection.

U.S. Pat. No. 7,008,056 describes protective glasses, which in a preferred embodiment contain a thin film filter, which is inserted between two plastic lens layers, and thus is protected against mechanical wear. The manufacture of glasses of this type, however, is cost-intensive, and they do not provide a broad band protection against IR-radiation.

### BRIEF SUMMARY OF THE INVENTION

It is therefore the objective of the invention to create an optical protective filter and a method for its manufacture of the type initially mentioned, which eliminates the disadvantages mentioned above.

Therefore it is the objective of the invention to produce an optical protective filter in particular for the infrared range, which blocks the radiation over a broad band with a single coating. Further objectives of the invention are that the protective filter can be cost-effectively manufactured, is light in weight and not susceptible to scratching. A further objective of the invention is to manufacture IR-protection glasses, which comprise an enhanced resistance to impact. It is a further objective of the invention to provide a method for the manufacture of an optical protective filter, which assures a high manufacturing quality and production yield. A still further objective of the invention is to manufacture a protective filter with an anti-dazzle function, which provides a variable transmission of the light intensity within the visible wavelength range.

This objective is achieved by an optical protective filter and a method for its manufacture with the characteristics of the corresponding independent claims.

The optical protective filter includes at least a first and a second partial lens, wherein the first partial lens comprises a flexible substrate, a thin film filter is applied to the substrate, and the thin film filter includes at least one metallic layer with a layer thickness of between 2 nm (nanometres) and 100 nm. The substrate in the completed protective filter, thanks to its flexibility, is bent to the final shape as a whole; this in contrast to lenses, which, while comprising a curved (bent) shape and curved (bent) surfaces, have, however, been ground or cast into this curved shape.

The function of the thin film filter (“thin film optical filter”) or dichroic filter as is known is based on the fact, that the filter comprises a plurality of layers with differing refraction indexes (“dielectric stacks”). The layer thicknesses are within the range of the optical wavelengths and are designed as a Bragg-reflector, in order that for predefined wavelengths interferences occur, as a result of which certain wavelengths are transmitted and others are reflected. By means of the number and the thickness of the layers, it is possible to adjust the band width, the wavelengths and the amplitudes of the transmitted and reflected light proportions.

By the utilisation of a thin film filter with metallic surfaces it surprisingly becomes possible to bend the thin film filter with the flexible substrate, wherein the several stacked layers of the thin film filter are not destroyed or damaged by the bending. This is in contrast to the expectations from prior art, for example, in the already mentioned U.S. Pat. No. 7,008,056, in which the importance of a rigid substrate is emphasized, because the distortion or bending of dielectric stacks could lead to them being damaged. By the utilisation of the metallic intermediate layers, in addition a broad band filtering is possible. The filters therefore do not anymore function as Bragg-reflectors, but rather absorb and reflect a large part of the electromagnetic radiation at the metallic layers, except for that part of the spectrum, for which constructive interference takes place, in a similar manner to a Fabry-Perot resonator.

The flexibility of the substrate of the first partial lens has the effect that it is capable of first being coated and subsequently bent into the shape, in which it is utilised in the completed protective filter. With this, it is possible to utilise known planar coating processes, which make possible a better quality than methods for the coating of curved (bent) surfaces.

The thin film filter, in preference, alternatingly includes a layer out of a dielectric and a metal. The dielectric layers include a relatively high refraction index and a thickness within the range of λ/2 or λ/4, wherein λ is the wavelength of the component to be transmitted.

The metallic layers out of, for example, silver or aluminium include a significantly smaller thickness, within the order of magnitude of, for example 10 nm (nanometres). As a result, they are approximately 10 to 20 to 50 times thinner than the dielectric layers.

In a preferred embodiment of the object of the invention, the thin film filter includes solely two external dielectric layers with a thickness of approximately λ/4, as well as a central metallic layer. In other preferred embodiments of the invention, further dielectric layers are present inside the filter, each with a thickness of approximately λ/2. Utilised as dielectrics are non-conductive optically transparent materials, typically metallic oxides, such as, for example, Al₂O₃, SiO₂, TiO₂, HfO₂, ZnS or Ta₂O₅. Alternatively, it is possible that individual ones or all of the dielectric layers consist of organic dielectrics.

In a further preferred embodiment of the object of the invention, by the selection of the layer thicknesses the optical filter is designed as a laser protection filter, this in particular for the infrared range, i.e., for wavelengths of between 800 nm and 2000 nm. In doing so, the filter, in preference, implements a protection level of more than L4, i.e., a reduction of the intensity by more than the factor 10,000. At the same time, the filter, in preference, achieves a transmissibility of more than 30% within the visible range. For this purpose, the thin film filter typically consists of 10 to 20 alternating layers of metals and dielectrics.

In a further preferred embodiment of the invention, the optical protective filter at a wavelength of 532 nm includes a protection level greater than or equal to L4, this in particular by means of a color dye introduced into at least one of the partial lenses. With this, the optical filter achieves a combined protective effect within different wavelength ranges. Instead of the filtering at 532 nm (corresponding to an Nd:YAG laser), it is alternatively or additionally possible that the filtering is adapted to other wavelengths, for example, 266 nm, 355 nm, 1064 nm. It is possible that these color dyes, for example, consist of metallic porphyrines, metallic phthalocyanines and their relatives, cyanines or of other compounds, which absorb certain wavelengths within the electro-magnetic spectrum.

In a further preferred embodiment of the invention, the optical protective filter includes one or several controllable or automatically darkening optical filter layers, in order to influence or to vary the visible light transmission. In doing so, in preference also, these filter layers are arranged on bent, curved and if so required also on flexible substrates. The controllable layers, for example, are based on electrically triggered liquid crystals, for example, of the type twisted nematic (TN), supertwisted nematic (STN), low twisted nematic (LTN), high twisted nematic (HTN), hybrid aligned (HA), vertically aligned (VA), optically compensated bend mode (OCB). It is also possible to utilise guest-host cells, or PLZT-modulators, modulators that are based on the electro-optical effect, or electro-chromic materials. Alternatively, it is also possible that the layers darken automatically in dependence of an impinging light intensity, such as, for example, with photo-chromic materials or reverse saturatable absorbers. It is also possible to utilise several layers of this kind, in order to increase the contrast. Automatically darkening materials can also be introduced into the material of one or of several partial lens, so that no additional layer or foil is necessary. It is also possible to arrange several such filter layers in a serial arrangement, i.e. behind one another, wherein the several filter layers can be arranged both in front of as well as behind the thin film filter. With these variable filter layers it is possible to achieve the function of an anti-dazzle filter, for example, for eye protection during welding processes.

In further preferred embodiments of the invention, holographic protection layers are applied inside the filter, and/or further layers, such as anti-fog-layers or scratch-proof layers are applied to the outside of the filter arrangement.

For manufacturing an optical filter, in preference, one proceeds as follows: The layers of the thin film filter are applied to a planar, respectively, flatly arranged substrate. This is done, for example, by evaporation, a chemical process or sputtering. Thereby, however, the substrate is made out of a flexible material and subsequently is bent into a shape in which it is to be utilised in the completed protective filter. It is possible to obtain this shape, for example, by bending the substrate and fixing it against a second bent (curved) and comparably inflexible partial lens, or by bending the substrate and inserting the substrate into a casting mold in the bent state, and injection-molding a material around the substrate, which material, after hardening, forms the second partial lens. It is also possible that the substrate is injection molded around the substrate on both sides, so that thereby a second and a third partial lens are formed.

The bending of the substrate, in preference, only takes place in one bending direction, so that the substrate and with this also the first partial lens include cylindrical surfaces. Thereby, also the second partial lens includes one or two cylindrical surfaces. It is, however, also conceivable, that a slight bending in a second direction is realized, so that the surfaces are approximately ellipsoid surfaces. The bending furthermore takes place at normal ambient temperatures, therefore without any heating.

Further preferred embodiments correspond to the dependent claims. Thereby, limitations of the method claims can be combined with those of the device claims and vice versa.

### BRIEF DESCRIPTION OF THE DRAWINGS

In the following, the object of the invention is described in more detail on the basis of preferred examples of embodiments, which are depicted on the attached drawings. These respectively schematically illustrate:

FIG. 1 an optical protective filter in cross section;

FIG. 2 a variant of the optical protective filter;

FIG. 3 method steps for the manufacturing of a protective filter; and

FIGS. 4 and 5 protective filters with filter layers with variable transmission.

The reference marks utilised in the drawings and their significance are listed in summary in the list of reference marks. On principle, in the Figures the same parts are designated with the same reference marks.

### DETAILED DESCRIPTION OF THE INVENTION

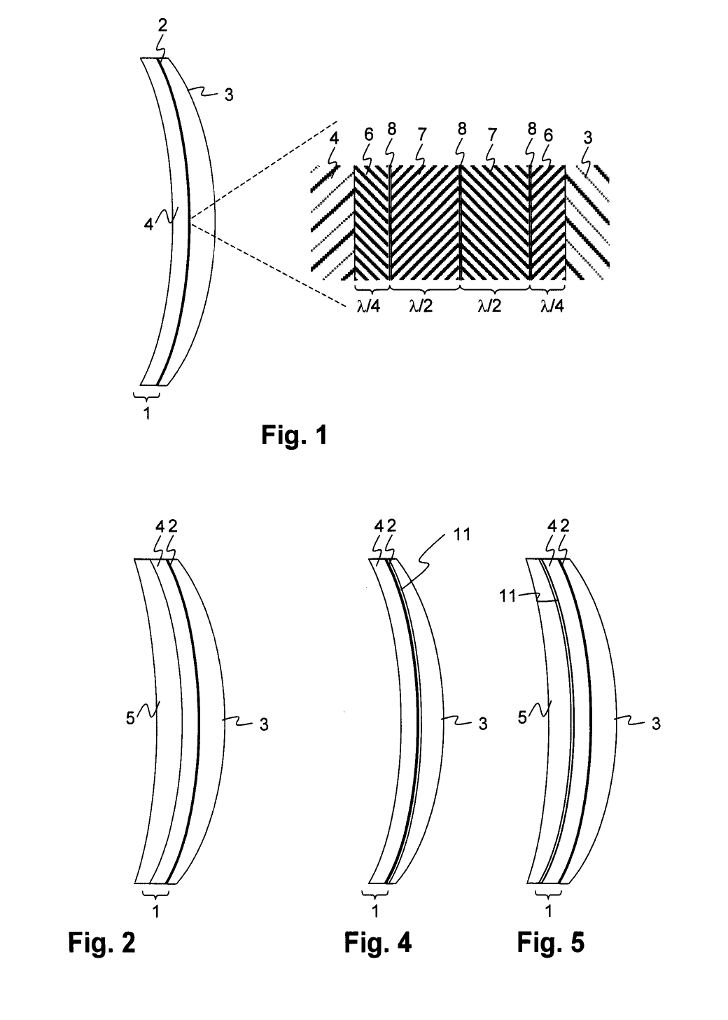

FIG. 1 illustrates a cross section through an optical protective filter made of two partial lenses or half lenses 1, 3, which, e.g., have been joined together with an adhesive. The first half lens 1, in a preferred embodiment the inside one, comprises a flexible substrate 4 and a thin film filter 2. The thin film filter 2 comprises one or several metallic layers, which absorb light, and alternatingly with these several dielectric layers, e.g., metal-oxide layers, which in constructive interference lead to a high light transmitting capacity in the visible range. A filter layer 2 of this type, in contrast to pure dielectric layers made of metal-oxides, is flexible and does not break also in the case of relatively small bending radii! A filter layer 2 of this type is therefore exceedingly suitable for being applied to a flexible substrate 4 in a flat condition, which very much simplifies the manufacturing process. Subsequently, it is possible to bend the substrate 4 together with the filter layer 2 into the final shape. In doing so, the bending radii typically amount to 50-100 mm, the substrate thickness to 0.5 mm-2 mm, and the substrates typically are made of a transparent polymer, such as polycarbonate (PC) or acrylic glass (PMMA). The term “flexible” here signifies, that the substrate is capable of being brought from its originally flat condition into a condition bent at least in one dimension, without this leading to it being damaged by breaking, cracks, splinters, etc. The bending typically takes place at room temperature, it is also possible, however, that it is done at increased temperatures, in order to facilitate the bending.

The substrate 4, in preference, is punched out of a plate or is manufactured by an injection molding process. In doing so, it is possible that—in the unbent condition—it comprises a bent or curved surface on the uncoated side. After the bending, therefore differing bending radii of the outer and of the inner surface result. As a result of this, it is possible to reduce the optical aberrations of the complete arrangement 1, 2, 3.

A schematic, enlarged view of the thin film filter is also illustrated in FIG. 1. Applied to the substrate 4 are an external dielectric layer 6, a metallic layer 8 and then an internal dielectric layer 7. Subsequently, in preference, several internal dielectric layers 7 and metallic layers 8 respectively alternatingly follow, and for the completion of the filter once again an external dielectric layer 6.

The second partial lens or half lens 3, in one preferred embodiment the external one, provides mechanical protection. In preference, it is less flexible than the first partial lens 1, inasmuch as it is thicker than that one and/or made out of a less flexible material. As a result, the second partial lens 3 stabilises the shape of the first partial lens 1 and with this defines the curvature of the filter 2. The utilisation of a different material for the second partial lens 3 than for the substrate 4 makes possible the manufacture of protective glasses highly resistant against blows. Thus, for example, it is possible to utilise a hard material for the second partial lens 3, which may splinter, wherein the inner and flexible first partial lens 1 located behind it subsequently protects the eyes from splinters. As material for the second partial lens 3, in a preferred embodiment, it is possible to utilise an acrylic resin, such as, for example, polymethylmethacrylate (PMMA).

The second partial lens 3 may also comprise differing curvature radii on the inside and on the outside, this in order to reduce aberrations.

In a preferred embodiment, the second partial lens 3 comprises a one-dimensional curvature, which makes it possible to bring the first partial lens 1 into shape in a simple manner. A one-dimensional curvature corresponds to a generalised cylinder, and in this special case to a regular (circular) cylinder or to an elliptical cylinder.

It is possible that further partial lenses are present, for example an optional third partial lens 5 in such a manner, that the first partial lens 1 is arranged between the second partial lens 3 and the third partial lens 5. This is depicted in FIG. 2 in cross section. In a further example (not illustrated), it is possible that a third partial lens 5 or a laminate of additional lenses is arranged in front of the second partial lens 3 in order to further increase the resistance against blows.

One or several of the partial lenses 1, 3, 5 may in addition be provided with an absorbent color dye in the material of the partial lens 1, 3, 5, in order to provide an additional protection in certain wavelength ranges; e.g., laser protection for 532 nm.

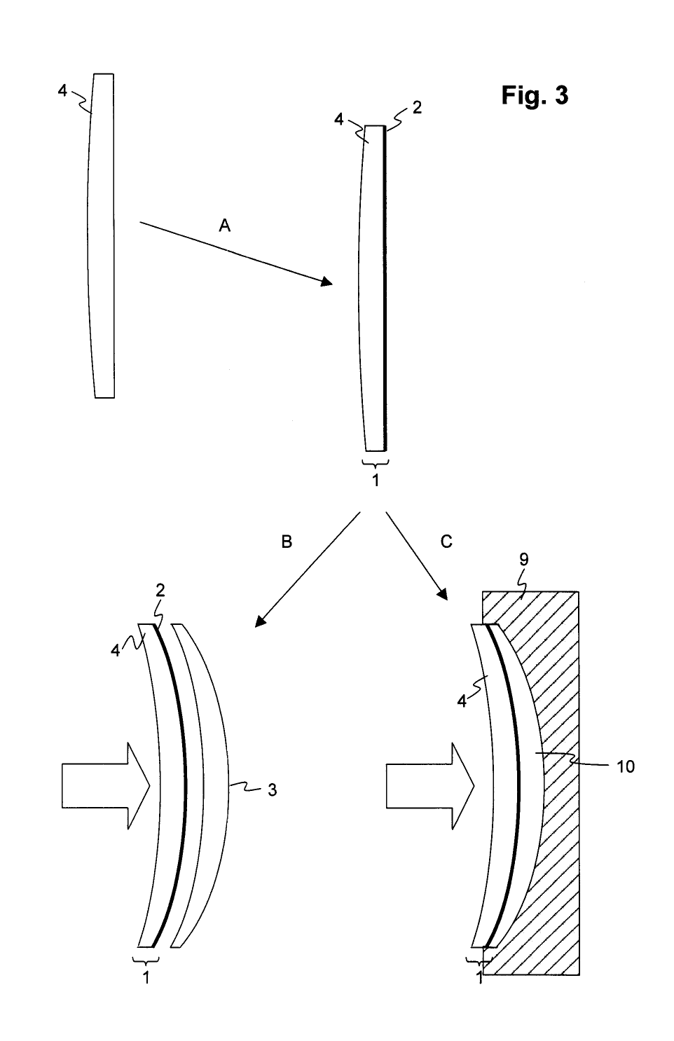

FIGS. 4 and 5 illustrate an embodiment of the invention, in which further filter layers 11 with transmissibilities that are variable over the course of time are present—this in particular within the visible range. The filter layers 11, in preference, are controllable liquid crystal—or guest-host cells, or photochromic materials in their own layers or foils, or else embedded in the material of one or of several of the partial lens. It is also possible to arrange several cells in series, in order to increase the contrast.

In FIG. 4, the variable filter layer 11 is arranged in front of or outside—with respect to the direction of impingement of the light—the thin film filter 2. Here, as in the case of the other Figures, one assumes that light falls on the convex side of the filters from the right or from the outside, and that an observer with his eyes is situated on the left or “inside” on the concave side. The variable filter layer 11, in particular a liquid crystal cell, is protected by the surrounding partial lens, and no additional lens in necessary. Furthermore, reflections of the IR-filter towards the outside are partially absorbed, which in the case of military applications is an advantage.

In FIG. 5 the variable filter layer 11 is arranged behind or inside the thin film filter 2. This has the advantage, that a degradation of the filter layer 11 by UV-light is reduced, which otherwise in case of organic components, such as polarizers and liquid crystals, may represent a problem.

In FIG. 3 method steps for manufacturing a composite protective filter are illustrated. Departing from a substrate 4, in a first step A, the layers of the thin film filter 2 are applied to a planar surface of the substrate 4. Subsequently, for example, in a further step B, the partial lens 1 produced in this manner is bent—as indicated by the block arrow—and attached to the second partial lens 3 or else fixed to it. This attaching or fixing, for example, takes place by gluing with a transparent adhesive over the whole surface of the partial lens, or gluing or gluing together the partial lens in an edge zone (not shown in the drawing). The adhesives may be, for example, on the basis of epoxy, acrylates or silicones, etc., and may be provided in the form of a liquid adhesive or adhesive foil or other correspondingly suitable forms, which are utilised for the optical gluing together of transparent laminates.

Alternatively (step C) the first partial lens 1 is bent—as indicated by the block arrow—and placed into an injection molding mold 9 and extrusion coated at least on that side, which carries the thin film filter 2. As a result of this, the second partial lens 3 is formed in a hollow space 10 of the mold 9 in an analogous manner, it is also possible to attach or extrusion-mold a third partial lens onto the other side.

### LIST OF REFERENCE MARKS

1 First partial lens

2 Thin film filter

3 Second partial lens

4 Substrate

5 Third partial lens

6 External dielectric layer

7 Internal dielectric layer

8 Metallic layer

9 Injection moulding mould

10 Hollow space

11 Filter layer with variable transmissibility

1. An optical protective filter, comprising:
at least one first and one second partial lens (1, 3),
wherein:
the first partial lens (1) is manufactured out of a flexible substrate (4),
a thin film filter (2) is applied to the substrate (4), and
the thin film filter (2) comprises at least one metallic layer (8) with a layer thickness of between 2 nm and 100 nm.

2. The optical protective filter in accordance with claim 1, wherein the first partial lens (1) and also the second partial lens (3) comprise a curvature in at least one direction.

3. The optical protective filter in accordance with claim 1, wherein the partial lenses (1, 3) lie against one another with a positive fit and are glued together.

4. The optical protective filter in accordance with claim 1, wherein an external partial lens (3) consists of a first material with increased resistance against blows, and wherein an internal partial lens (1) is made of a second material which differs from the first material.

5. The optical protective filter in accordance with claim 1, wherein the thin film filter (2) alternatingly comprises dielectric layers (6, 7) and metallic layers (8), wherein the dielectric layers (7, 8) are at least ten times thicker than the metallic layers (8), and the two external layers (6) of the thin film filter (2) are dielectric layers.

6. The optical protective filter in accordance with claim 1, which acts as a laser protection filter and in a wavelength range of between 800 nm up to 2,000 nm, and achieves a protection with a protection level of higher than or equal to L4, and which has a transmissibility of over 30%.

7. The optical protective filter in accordance with claim 6, in which the material of one or of several partial lens (1, 3, 5) comprises a color dye which causes the optical protective filter at a wavelength of 532 nm to exhibit a protection level greater than or equal to L4.

8. The optical protective filter in accordance with claim 1, further comprising one or several optical filter layers (11) with variable transmissibility, wherein these filter layers (11) are arranged on curved or flexible substrates.

9. The optical protective filter in accordance with claim 8, wherein the one or the several filter layers (11) with variable transmissibility are electrically controllable and comprise a liquid crystal and/or a guest-host cell.

10. The optical protective filter in accordance with claim 8, wherein the one or the several filter layers (11) with variable transmissibility are automatically darkening and comprise a photochromic layer.

11. The optical protective filter in accordance with claim 8, further comprising two or more filter layers (11) with variable transmissibility, which are electrically controllable and comprise a liquid crystal and/or a guest-host cell and are arranged in a series configuration.

12. Protective device for welders, in particular a protection mask for welders or protection goggles for welders, comprising an optical protective filter (1, 3) in accordance with claim 1.

13. method for the manufacture of an optical protective filter in accordance with claim 1, which method comprises the following steps:
Providing a flexible substrate (4);
applying the thin film filter (2) to the flexible substrate (4) in a flat condition, and by means of this, forming a first partial lens (1);
bending the first partial lens (1) and joining the first partial lens (1) to a second partial lens (3).

14. The method for the manufacture of an optical protective filter in accordance with claim 13, wherein the step of bending and joining the first partial lens (1) comprises:
Pressing the first partial lens (1) against a curved surface of the second partial lens (3), and by means of this bending the first partial lens (1);
fixing the first partial lens (1) relative to the second partial lens (3).

15. The method for the manufacture of an optical protective filter in accordance with claim 13, wherein the step of joining the first partial lens with the second partial lens comprises:
Bending the first partial lens (1) and inserting it into an injection molding mold (9);
injection molding the second partial lens (3) to the first partial lens (1).
